(19) United States
(12) Patent Application Publication
(10) Pub. No.: US 2026/0128630 A1
(43) Pub. Date: May 7, 2026

(54) ROTOR FOR RESOLVER AND RESOLVER

(71) Applicant: MINEBEA MITSUMI Inc., Nagano (JP)

(72) Inventors: Yoshiya OONO, Kitasaku-gun, Nagano (JP); Takaaki OCHIAI, Kitasaku-gun, Nagano (JP)

(21) Appl. No.: 19/117,499

(22) PCT Filed: Sep. 25, 2023
(86) PCT No.: PCT/JP2023/034736

§ 371 Date: Apr. 1, 2025

(30) Foreign Application Priority Data
Oct. 3, 2022 (JP) 2022-159506

(51) Int. Cl. H02K 1/28; H02K 24/00

(52) U.S. Cl. CPC H02K 1/28; H02K 24/00

(57) ABSTRACT

A rotor for a resolver is fixed to a shaft of a motor by press-fitting the shaft into a hole having a substantially circular shape. Two protruding parts are provided at an outer peripheral surface of the rotor and protrude radially outward in a circumferential direction at equal circumferential intervals, a protruding part located at a substantially central part in the circumferential direction of the protruding part and protruding toward the center of the hole is provided at an inner peripheral surface of the rotor, and a recessed part is located at a substantially central part in the circumferential direction of the protruding part opposite to the protruding part at 180° and recessed radially outward.

### TECHNICAL FIELD

The present invention relates to a rotor for a resolver, and particularly, to an improvement in a structure for fixing a shaft of a motor to a rotor.

### BACKGROUND ART

In the related art, as a rotor for this type of resolver, there is known a configuration having a protrusion protruding toward the center provided at an edge of an inner hole of the rotor and fitted into a recessed part serving as a key groove formed at an outer periphery of a shaft to integrally fix the rotor to the shaft (for example, see Patent Document 1).

A rotor 1 described in Patent Document 1 has a shaft multiple angle of 2X (double angle), and one protrusion 3A is formed at an inner diameter wall 1Aa forming the inner diameter of an inner hole 1A of the rotor 1 to protrude to a shaft center P side, an outer periphery of the rotor 1 being a protruding part at two locations at the shaft multiple angle.

An axially recessed part 11 serving as a key groove is formed at an outer periphery of a rotating shaft 10, and relief recessed parts 3Aa and 3Ab are formed at both sides of the protrusion 3A so that respective corner parts 11a and 11b formed at both sides of the axially recessed part 11 can enter and escape when the rotating shaft 10 is press-fitted into the inner hole 1A of the rotor 1 so that the protrusion 3A and the axially recessed part 11 are fitted.

### CITATION LIST

### Patent Document

Patent Document 1: JP 2002-174535 A

### SUMMARY OF INVENTION

### Technical Problem

In Patent Document 1, when the rotating shaft 10 is press-fitted into the inner hole 1A of the rotor 1 and the rotor 1 is fixed at the rotating shaft 10, the inner hole 1A has a non-circular shape due to press-fitting at the entire surface of an inner peripheral edge except for the periphery of the protrusion 3A, and stress at the time of press-fitting is not uniform in the circumferential direction. Therefore, the deformation of the two protruding parts at the outer peripheral surface of the rotor 1 is non-uniform, and an air gap between the protruding parts and a stator 100 is non-uniform. This causes waveform distortion of a rotation angle signal generated by the protruding part, and may affect the accuracy of an angle to be detected.

The present invention has been made in view of the above circumstances, and an object of the present invention is to provide a rotor for a resolver capable of suppressing non-uniform deformation of a protruding part when a rotating shaft is press-fitted into the rotor.

### Solution to Problem

The present invention is a rotor for a resolver fixed to a shaft of a motor by press-fitting the shaft into a hole having a substantially circular shape and, includes a plurality of protruding parts provided at an outer peripheral surface of the rotor and protruding radially outward in a circumferential direction at equal circumferential intervals, wherein a protruding part located at a substantially central part in the circumferential direction of the protruding part and protruding toward a center of the hole is provided at an inner peripheral surface of the rotor, and a recessed part is located at a substantially central part in the circumferential direction of another protruding part and recessed radially outward.

### Advantageous Effects of Invention

The present invention can suppress non-uniform deformation of a protruding part when a shaft is press-fitted into a rotor.

### BRIEF DESCRIPTION OF DRAWINGS

FIG. 1 is a plan view illustrating a rotor in an embodiment of the present invention.

FIG. 2 is a plan view illustrating a resolver in the embodiment of the present invention.

FIG. 3 is an enlarged view of a portion indicated by an arrow III in FIG. 1.

FIG. 4 is an enlarged view of a portion indicated by arrow IV in FIG. 1.

FIG. 5 is an enlarged view of a portion indicated by an arrow V in FIG. 2.

FIG. 6 is an enlarged view of a portion indicated by an arrow VI in FIG. 2.

FIG. 7 is a graph showing an outer diameter deformation amount of a rotor when a shaft is press-fitted into the rotor.

### DESCRIPTION OF EMBODIMENTS

### 1. Configuration of Rotor

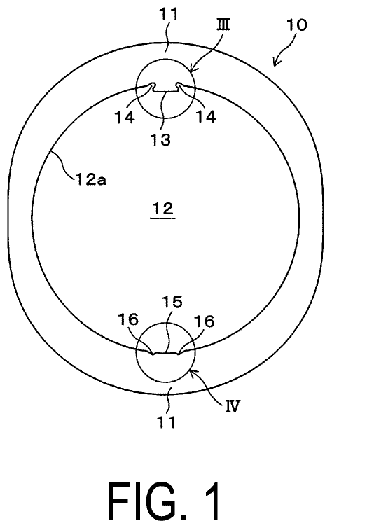

FIG. 1 is a view illustrating a rotor 10 for a variable reluctance (VR) type resolver. The rotor 10 is integrally formed by stacking a predetermined number of cores in an axial direction by caulking, welding, or the like, the core being formed by pressing a magnetic steel sheet (silicon steel sheet or electromagnetic steel sheet) into a predetermined shape (for example, a substantially elliptical shape). In the following description, assuming that the rotor 10 illustrated in FIG. 1 has a vertical center line, a position above the center line is 0°, a position below the center line 180°, and each position is indicated by an angle in a clockwise direction.

A shaft multiple angle of the rotor 10 is a double angle (2X), and protruding parts 11 are formed at two locations of 0° and 180° at an outer peripheral surface of the rotor 10, for example, so as to have a substantially elliptical shape. A hole 12 having a substantially circular shape is formed at the center of the rotor 10. In the following description, a direction passing through the center of the hole 12 is referred to as an axial direction, a direction perpendicular to the axial direction is referred to as a radial direction, and a direction rotating around the axial direction is referred to as a circumferential direction.

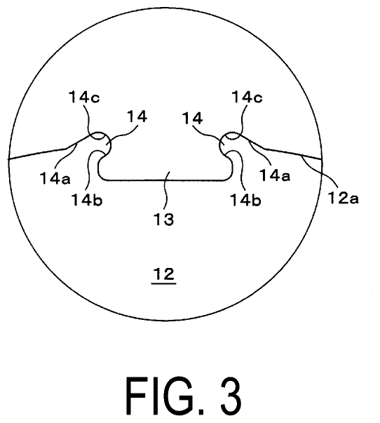

An inner peripheral surface of the hole 12 is provided with a protruding part 13 located at a circumferential center of a protruding part 11, protruding toward the center direction of the hole 12, and extending in the axial direction. Relief grooves 14 are formed at both sides of a root of the protruding part 13. As illustrated in FIG. 3, the relief groove 14 includes a pair of inclined surfaces 14a and 14b extending in the circumferential direction of an inner peripheral surface 12a of the rotor 10 and radially outward from the inner peripheral surface 12a, and a cylindrical surface 14c connected to end parts of the inclined surfaces 14a and 14b and forming a bottom part of the relief groove 14. The size of the relief groove 14 is set to ensure the strength of the protruding part 13.

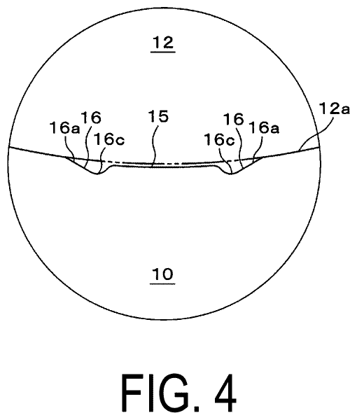

In the hole 12, the inner peripheral surface 12a at a position facing the protruding part 13 at 180° is formed with a recessed part 15 recessed radially outward. The recessed part 15 has a flat surface and is located radially outward from the inner peripheral surface 12a. Second recessed parts 16 are formed at both sides of the recessed part 15. As illustrated in FIG. 4, the second recessed part 16 includes an inclined surface 16a extending in the circumferential direction of the inner peripheral surface 12a of the rotor 10 and radially outward from the inner peripheral surface 12a, and a cylindrical surface 16c connected to an end part of the inclined surface 16c and forming a bottom part of the second recessed part 16. The second recessed part 16 is line-symmetrical to the relief groove 14 with respect to a line connecting positions of 90° and 270° in the circumferential direction. Instead of the flat surface, the recessed part 15 may be an arc-shaped curved surface formed concentrically with the inner peripheral surface 12a.

### 2. Method of Manufacturing Resolver

The hole 12 is punched out from a long electromagnetic steel sheet. In this case, the protruding part 13 and the relief groove 14 are formed at a position of 0° at the inner periphery of the hole 12, and the same shape as the protruding part 13 and the relief groove 14 is formed at a position of 180° at the inner periphery of the hole 12. In a subsequent step, the recessed part 15 having the second recessed part 16 is formed by punching out the shape of the protruding part 13. The reason why such a process is performed is that when the recessed part 15 and the second recessed part 16 are formed by one-time punching, a boundary part between the cylindrical surface 16c of the second recessed part 16 and the recessed part 15 sags and the recessed part 15 and the second recessed part 16 are not accurately formable. Subsequently, a rotor core piece having the shape illustrated in FIG. 1 is punched out from the electromagnetic steel sheet. A predetermined number of punched rotor core pieces are stacked in the axial direction and integrated by means such as caulking or welding to form the rotor 10.

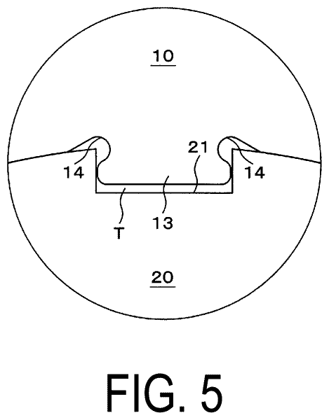

Subsequently, a shaft (rotating shaft) 20 of a motor (not shown) is press-fitted into the hole 12 of the rotor 10. As illustrated in FIG. 5, a key groove 21 having a rectangular cross-sectional shape is formed at the outer periphery of the shaft 20, and the protruding part 13 of the rotor 10 is fitted into the key groove 21. In this state, a corner part of the key groove 21 is accommodated in the relief groove 14, and a gap T is formed between a bottom part of the key groove 21 and the protruding part 13.

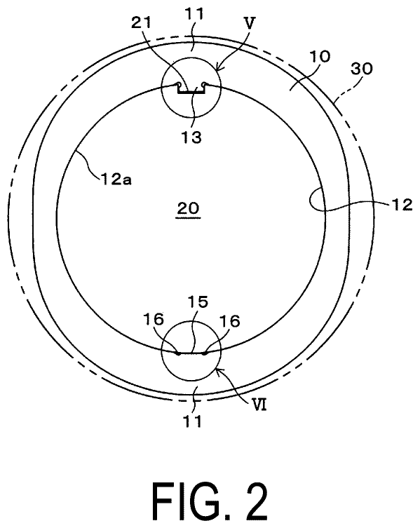

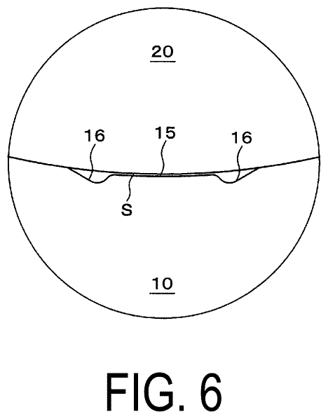

As illustrated in FIG. 6, a gap S is formed between the recessed part 15 at the position of 180° at the inner periphery of the hole 12 and an outer peripheral surface of the shaft 20. Subsequently, the rotor 10 is disposed inside a stator 30 of the resolver and the resolver illustrated in FIG. 2 is completed. When the shaft 20 rotates, the protruding part 11 of the rotor 10 crosses a coil wound around teeth (not illustrated) of the stator 30, and a rotation angle signal is generated.

### 3. Effect

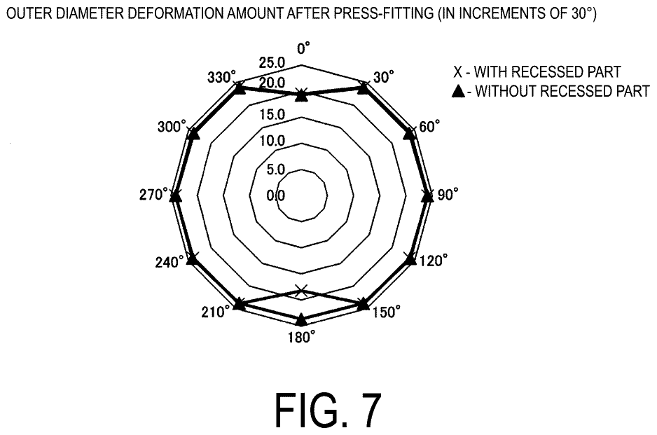

FIG. 7 is a graph obtained by computer simulation of the amount of deformation of the outer diameter of the rotor 10 when the shaft 20 is press-fitted into each of the rotor 10 of the present embodiment and a rotor of a comparative example having no recessed part 15 with a predetermined interference. In the rotor of the comparative example, a protruding part at a position of 0° at an inner periphery of a hole is not in contact with the shaft at the time of press-fitting, so that the deformation is small, and the other portion is expanded by the shaft 20 and the deformation is increased.

As illustrated in FIG. 7, in the rotor of the comparative example, the amount of deformation in the range (range of from 30° to 330°) where the press-fitting is performed is larger than the amount of deformation at the position of the protruding part, and no large difference occurs in the amount of deformation in this range (range of from 30° to 330°). The amount of deformation at a position of 180° at the inner periphery of the hole is also large, and a large difference occurs from the amount of deformation at the position of 0° at the inner periphery of the hole. Therefore, since a large difference occurs between an air gap between a protruding part at the position of 0° at the inner periphery of the hole and a stator and an air gap between a protruding part at the position of 180° at the inner periphery of the hole and the stator, waveforms of rotation angle signals generated by the two protruding parts are different from each other, resulting in an adverse influence on angle accuracy.

On the other hand, in the rotor 10 of the embodiment, since the recessed part 15 is not in contact with the outer periphery of the shaft 20, no large difference occurs in the amount of deformation at the positions (positions of 0° and 180°) of the two protruding parts 11 at the outer peripheral surface of the rotor 10. Thus, no large difference occurs between an air gap between the stator 30 and the protruding part at the position of 0° at the inner periphery of the hole 12 and an air gap between the stator and the protruding part at the position of 180° at the inner periphery of the hole 12. Therefore, waveforms of rotation angle signals generated by the two protruding parts 11 are also almost the same, so that the influence on angle accuracy caused by the rotor as in the comparative example can be suppressed.

In particular, in the above embodiment, since the second recessed parts 16 are provided at both sides of the recessed part 15 formed at the position facing the protruding part 13 at 180° and are line-symmetrical to the relief grooves 14 with respect to the line connecting the positions of 90° and 270° in the circumferential direction, the shapes of the second recessed part 16 and the relief groove 14 coincide with each other and the amounts of deformation of the second recessed part 16 and the relief groove 14 can be made equal to each other, so that the difference in the amount of deformation between the positions of 0° and 180° at the inner periphery of the hole 12 can be extremely reduced.

In addition, in the above embodiment, since the relief groove 14 is formed to extend in the circumferential direction of the inner peripheral surface 12a and to extend radially outward from the inner peripheral surface 12a, the burr of the edge (corner part) of the key groove 21 formed at the shaft 20 is accommodated in the relief groove 14 regardless of the direction of the burr.

Moreover, in the above embodiment, since the relief groove 14 includes the pair of inclined surfaces 14a and 14b extending in the circumferential direction of the inner peripheral surface 12a of the rotor 10 and radially outward from the inner peripheral surface 12a, and the cylindrical surface 14c connected to the end parts of the inclined surfaces 14a and 14b and forming the bottom part of the relief groove 14, stress is distributed in the cylindrical surface 14c when the protruding part 13 is pressed by the edge of the key groove 21, so that stress concentration is suppressed.

### 4. Modification Examples

The present invention is not limited to the embodiment described above, and various modifications can be made as described below.
i) In the above embodiment, the shaft multiple angle of the rotor 10 is the double angle (2X) and the protruding parts 11 are formed at two positions of 0° and 180° at the outer peripheral surface of the rotor 10; however, the shaft multiple angle of the rotor can be a triple angle (3X) and the protruding parts protruding radially outward can be formed at three positions of 0°, 120° and 240° at the outer peripheral surface of the rotor. In this case, a protruding part is provided at the position of 0° at the inner peripheral surface of the hole, and recessed parts are provided at the positions of 120° and 240°. Similarly, the present invention can be applied to when the shaft multiple angle is a quadruple angle (4X) or a quintuple angle (5X).
ii) When three or more protruding parts are provided at the outer periphery of the rotor, relief grooves can be provided at both sides of the root of the protruding part, and second recessed parts having the same shape and size as the relief grooves can be provided at both sides of the recessed part.
iii) In the above embodiment, the second recessed parts 16 are provided at both sides of the recessed part 15 formed at the position facing the protruding part 13 at 180°; however, the second recessed parts 16 are not necessarily required in order to obtain the effect of the present invention.

### INDUSTRIAL APPLICABILITY

The present invention can be used in a rotor for a VR type resolver.

### REFERENCE SIGNS LIST

10 Rotor, 11 Protruding part, 12 Hole, 12a Inner peripheral surface, 13 Protruding part, 14 Relief groove, 14a, 14b Inclined surface, 14c Cylindrical surface, 15 Recessed part, 16 Second recessed part, 16a Inclined surface, 16c Cylindrical surface, 20 Shaft, 21 Key groove, 30 Stator, S, T Gap

1. A rotor for a resolver fixed to a shaft of a motor by press-fitting the shaft into a hole having a substantially circular shape, comprising:
a plurality of protruding parts provided at an outer peripheral surface of the rotor and protruding radially outward in a circumferential direction at equal circumferential intervals,
wherein a protruding part located at a substantially central part in the circumferential direction of the protruding part and protruding toward a center of the hole is provided at an inner peripheral surface of the rotor, and a recessed part is located at a substantially central part in the circumferential direction of another protruding part and recessed radially outward.

2. The rotor for a resolver according to claim 1, wherein a relief groove is formed at both sides of a root of the protruding part, extends in the circumferential direction of the inner peripheral surface, and extends radially outward from the inner peripheral surface.

3. The rotor for a resolver according to claim 1, wherein the relief groove comprises a pair of inclined surfaces extending in the circumferential direction of the inner peripheral surface of the rotor and radially outward from the inner peripheral surface, and a cylindrical surface connected to end parts of the inclined surfaces and forming a bottom part of the relief groove.

4. The rotor for a resolver according to claim 2, wherein second recessed parts are provided at both sides of the recessed part and have the same shape and size as a shape and a size of the relief groove.

5. The rotor for a resolver according to claim 1, wherein the number of the protruding parts at the outer peripheral surface of the rotor is two.

6. The rotor for a resolver according to claim 4, wherein the second recessed part is line-symmetrical to the relief groove with respect to a line connecting positions of 90° and 270° in the circumferential direction.

7. The rotor for a resolver according to claim 1, wherein the recessed part is a flat surface or an arc-shaped curved surface formed concentrically with the hole.

8. A resolver comprising the rotor for the resolver according to claim 1, wherein the rotor is located inside a stator, and a shaft of a motor having a key groove at an outer periphery of the shaft is press-fitted into the hole by fitting the protruding part into the key groove.
